(19) United States
(12) Patent Application Publication
(10) Pub. No.: US 2017/0341548 A1
(43) Pub. Date: Nov. 30, 2017

(54) SLEEPING HEAD SUPPORT METHOD AND APPARATUS

(71) Applicants: Kirk Perry, Arlington, TX (US); Julie Perry, Arlington, TX (US)

(72) Inventors: Kirk Perry, Arlington, TX (US); Julie Perry, Arlington, TX (US)

(21) Appl. No.: 15/168,500

(22) Filed: May 31, 2016

(51) Int. Cl. B60N 2/48

(52) U.S. Cl. CPC B60N 2/4879

(57) ABSTRACT

A system for securing a human head in an upright position during sitting is presented. The device includes a band, a pad section, and an attachment member. The band is configured to wrap around a portion of the head and a sitting device. The pad section is coupled to the band and configured to engage a portion of the human head. The attachment member secures the band around the head in order to maintain the upright orientation of the head. Additive materials and safety members may be used to increase comfort, function, and safety of the device.

### BACKGROUND

### 1. Field of the Invention

The present application relates to a head support device, and more particularly to a device used to keep a head in an upright position during sleeping and resting.

### 2. Description of Related Art

Sleep is important for human beings of all ages. During sleep, the muscles in the neck and back of the human body that normally support the head do not function. This is true for adults and more so for young children and babies. Baby's muscles in their back and neck are not as strong as those of an adult. When resting in a prostrate position the relaxing of the muscles is not of great importance. However, human beings often encounter times where sleep and rest are necessary when in a sitting position. An example is when riding in vehicles. Babies and small children especially find the motions of riding in a vehicle to promote a desire to fall asleep. When sleeping in a vehicle or in an upright position, the head will fall forward or “roll” to the left or right, placing strain on the neck and spine thereby causing discomfort. This affects the quality of sleep to be enjoyed. Additionally, induced motions by a driver (i.e. acceleration, braking, and turning) also can affect the position of the head during transportation.

Although many advancements have been made with a number of devices to help support the head while resting in an upright position, shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a front view of a head support system according to the preferred embodiment of the present application.

FIG. 2 is a back view of a head strap in the head support system of FIG. 1.

FIG. 3 is a front view of the head support system of FIG. 1 coupled around an infant's head.

FIG. 4 is a front view of an alternative embodiment of a support strap in the head support system of FIG. 1.

FIG. 5 is a front view of the head support system of FIG. 1 coupled around an adult head.

FIG. 6 is a side view of the head support system of FIG. 1 coupled around a child head.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with conventional head support systems. In particular, the system is configured to couple around a user's head and secure the head in an upright position during sleeping. The head support system can be used on the heads of any aged human being. The head support is configured to releasably couple around the head. For use with smaller users, the system is configured to selectively attach to a support strap in communication with the seat. Alternatively the system is configured to reach around the head and a portion of the seat without the use of the support strap. This is more likely used with larger users. These and other unique features of the system are discussed below and illustrated in the accompanying drawings.

The system and method will be understood, both as to its structure and operation, from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system and method of the present application is illustrated in the associated drawings. The system includes a band having one or more pad sections located at opposing ends of the band. The pad sections are configured with an attachment member so as to permit repeated attachment and detachment of the pad sections to one another. The pad sections are configured to overlap and secure a human's head in a particular orientation relative to a sitting device. The system may also include a support strap to coupling directly to any seat support device (i.e. booster, car seat, stroller . . . ). Additional features and functions of the system are illustrated and discussed below.

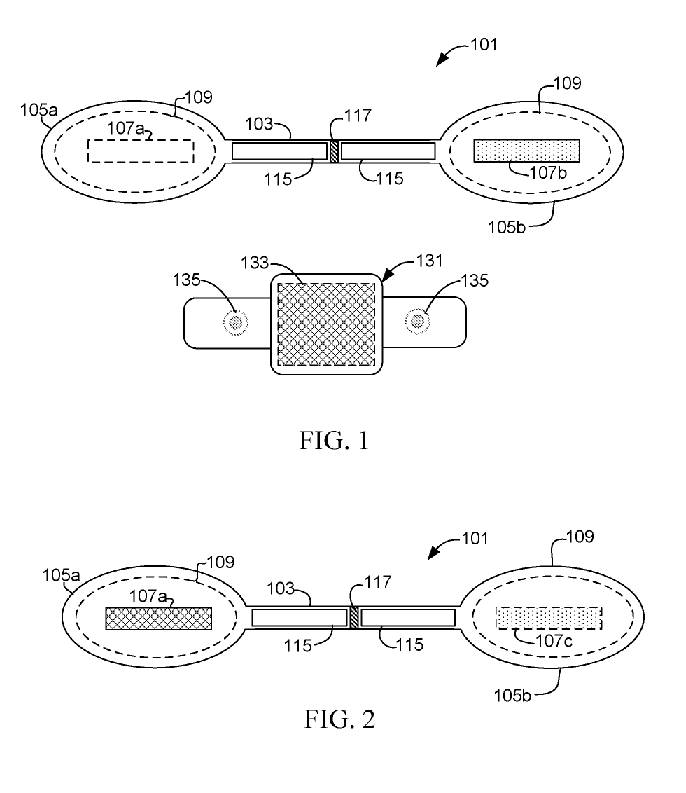

Referring now to the drawings wherein like reference characters identify corresponding or similar elements in form and function throughout the several views. FIGS. 1-2 illustrate assorted views of head support system 101 of the present application. System 101 is configured to maintain the head of a user in an upright position during sleep when the user is not in a prostrate position (laying horizontally).

System 101 includes a band 103, one or more pad sections 105a,105b, and an attachment member 107. System 101 may be made from any one of one or more pieces of fabric, elastic, composite, and so forth. System 101 is configured to be flexible in nature allowing it to wrap and bend around the human head without abrasion. Band 103 is an elongated member roughly in the shape of a rectangle. The depicted or described shape is not herein limiting.

One or more pad sections 105 are located at an end of band 103. As seen in FIGS. 1 and 2, a single pad section 105 is located at opposing ends of band 103. Pad section 105a/105b may optionally contain a pad 109 for comfort to the user. Pad 109 may be sewn into or coupled to section 105a/b on an external surface such that it is exposed; or pad 109 may be located internally between two surfaces of pad section 105a/b.

System 101 also includes attachment member 107. Member 107 is configured to secure pad section 105a/b around the user's head. Member 107 is able to take many different types of forms and is not herein limited to that described and shown. For example, member 107 may be located only on a single pad section as opposed to opposing pad sections as shown. In the Figures, attachment member 107 is found as a two-piece member wherein the first half 107a is coupled to pad section 105a and second half 107b is coupled to pad section 105b. Member 107 is depicted as a hook and loop fastener but may be replaced by at least any of a button configuration, snap configuration, adhesive configuration and so forth. Member 107 is configured to be reusable to allow for many uses. Members 107a and 107b may be attached and detached as desired by the user. As seen in FIG. 1, half 107a is shown on the back side of the depicted drawings compared to half 107b. In contrast, FIG. 2 depicts half 107b on the back side of the drawing while half 107a are shown in the foreground.

System 101 also may include a support strap 131 configured to selectively couple to a seat support device, such as the fabric of an infant car seat located behind the head of an infant. Strap 131 includes clasps 135 configured to secure strap 131 to the car seat. Clasps 135 can be any type of fastener, such as a button, hook and loop fastener, snap, clasp, and so forth. Support strap 131 also includes a support attachment member 133 for coupling directly to attachment member 107c of band 103. Attachment member 107c is opposite that of attachment member 107b. Attachment members 107a and 107b are configured to engage or bond when overlapped. Attachment member 107c is configured to couple to support attachment member 133. In operation, as band 103 is placed around an infant's head, attachment member 107c remains exposed along an outside surface and is configured to engage support attachment member 133. The infant's head may be orientated in different positions depending on the comfort of the child.

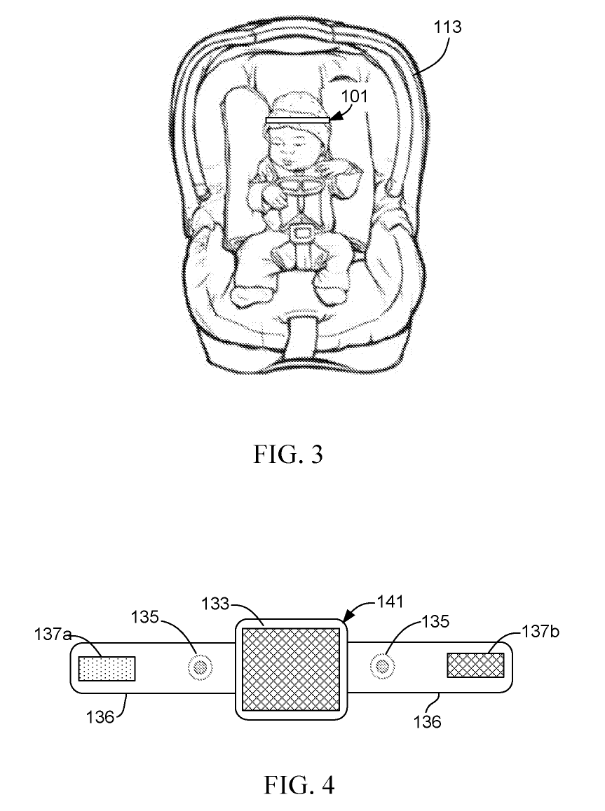

Referring now also to FIG. 3 in the drawings, system 101 is illustrated in operation with an infant in a car seat 113. In FIG. 3, an infant is found sitting in car seat 113. As stated previously, support strap 131 is configured to adhere/couple/attach to the fabric on car seat 113 via clasps 135. Band 103 is wrapped around the infant's head and attached to support attachment member 133.

Referring now also to FIG. 4 in the drawings, an alternative embodiment of support strap 131 is illustrated. Support strap 131 is suitable to be left continually attached in the car seat 113. It is conceived that, at times, it may be less than desirable for a parent to move the head of a sleeping child any more than necessary. Therefore support strap 141 is similar in form and function to that of support strap 131 except as noted herein. Strap 141 includes tabs 136 that extend out from clasps 135. Each tab 136 may also include a tab attachment member 137a/137b. The length of band 103 is able to be varied, such that band 103 attaches to tab attachment members 137a/137b as opposed to member 133. Tabs 136 are configured to rest along the sides of the infant's head when in car seat 113.

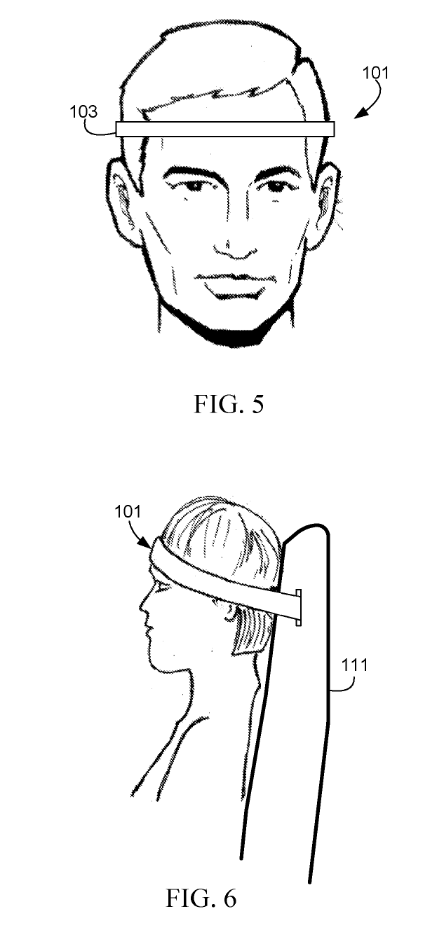

Referring now also to FIG. 5 in the drawings, system 101 is illustrated around an adult user's head. Band 103 is configured to strap around a user's head to keep it in a stable and upright orientation. An ideal location for band 103 to engage the user's head is along the forehead. Pad sections 105a/b are configured to overlap and secure band 103 around a seat. Members 107 are configured such that each half is configured to engage each other when overlapped. Attachment member 107c is not necessary when used with an adult head when wrapped around a seat.

In operation, system 101 is configured to either pass through or wrap around a portion of the sitting device so as to properly locate the head. A user may pre-route system 101 through or around the sitting device and selectively use it as necessary by merely attaching or detaching pad sections. This is clearly seen in FIG. 6.

Referring now also to FIG. 6 in the drawings, system 101 is illustrated in operation with a toddler in a sitting device, such as a booster. A sitting device is an object that is used by a human being to provide support when in a sitting position. It is preferably that this sitting device have a type of back support so as to support the head and/or neck of the human sitting. As seen in FIG. 4, a toddler is found sitting on a booster chair 111. In operation, system 101 is configured to either pass through or wrap around a portion of the sitting device so as to properly locate the head. A user may pre-route system 101 through or around the sitting device and selectively use it as necessary by merely attaching or detaching pad sections as necessary. The embodiment uses illustrated in FIGS. 5 and 6 do not need the use of strap 131/141.

Referring back to FIGS. 1 and 2 in the drawings, system 101 may include an additive material 115 found within band 103. Material 115 is configured to provide a either additional padding for the head, texturing for grip, tensioning, and so forth. For example, material 115 may be an additional pad. Furthermore, material 115 may be an elastic material configured to provide tensioning forces around the user's head so as to allow system 101 to adjust to various sized heads and sitting devices.

System 101 may further include a safety member 117 configured to regulate the amount of tensioning force applied to the user's head. Safety member 117 is configured to divide upon the occurrence of a predetermined amount of force. For example, if there was an accident in a vehicle and the head was thrown forward, safety member 117 is configured to divide, split, and/or separate, such that band 103 is divided to allow the head to move forward with the body. Member 117 is designed to accept a predetermined level of tensioning force prior to separation.

The current application has many advantages over the prior art including at least the following: (1) a selectively detachable method of securing the head of a human in an upright manner to allow for sleeping; (2) the use of an additive material to increase comfort and usability; and (3) an optional safety member to allow for a breakaway feature.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A sleeping head support system, comprising:
a band having a first end;
a first pad section in communication with the first end of the band;
a first attachment member adjacent the first end and configured to secure the band around a user's head;
wherein the band is selectively secured to a portion of a seating device so as to elevate the head at a desired orientation while the user is resting.

2. The system of claim 1, further comprising:
a second pad section in communication with a second end of the band, the second end being opposite the first end.

3. The system of claim 2, wherein the second pad section is configured to selectively couple to the first pad section.

4. The system of claim 2, wherein the first and second pad sections make contact with a head of the user when coupled.

5. The system of claim 2, wherein the second pad section includes a second attachment member.

6. The system of claim 1, wherein the first pad section is configured to include a pad.

7. The system of claim 1, further comprising:
an additive material in communication with the band.

8. The system of claim 7, wherein the additive material is configured to provide a tensioning force around the user's head.

9. The system of claim 8, wherein the additive material is made from elastic material.

10. The system of claim 7, wherein the additive material is a pad.

11. The system of claim 7, further comprising:
a safety member configured to divide upon the occurrence of a predetermined amount of force.

12. The system of claim 1, further comprising:
a support strap configured to selectively couple to the sitting device, the support strap including a support attachment member for coupling to the band.

13. The system of claim 12, wherein the support strap includes one or more securing devices to attach the support strap to the sitting device.

14. The system of claim 13, wherein the support attachment member is located between the securing devices.

15. The system of claim 13, wherein the support attachment member is located outside of the securing devices.
